(19) United States
(12) Patent Application Publication
(10) Pub. No.: US 2006/0146137 A1
(43) Pub. Date: Jul. 6, 2006

(54) Automated postcard dispensing apparatus

(76) Inventors: James Enos, Boca Raton, FL (US); Michael Anthony, Coral Springs, FL (US)

Correspondence Address: Mark D. Bowen;Stearns Weaver Miller, Suite 1900, 200 East Broward Boulevard, Fort Lauderdale, FL, 33301, US

(21) Appl. No.: 11/027,096

(22) Filed: Dec. 30, 2004

(51) Int. Cl. H04N 7/173; H04N 7/16; G06F 13/38; H04N 5/225; G06F 13/12

(52) U.S. Cl. 348/207.2; 710/72; 725/133; 725/141

(57) ABSTRACT

An automated personal postcard dispensing apparatus capable of obtaining an image provide by a user, incorporating a personalized text message, and printing a personalized postcard complete with proper postage affixed. The apparatus includes a cash-receiving device, a computer, a digital camera, a display monitor, a printer, a CD reader, a card reader, means to receive, store and, on command, present a pictorial background and instructions to the user flashed onto the monitor for quick and simple utilization by the user. The apparatus is preferably housed in a booth for location near heavily traveled tourist routes to facilitate use by many persons. The user is therefore easily able to send a fun, colorful record of their trip to friends and relatives showing them or images of their trip and further to save on postage costs by using postcard postage in lieu of letter postage. In addition, the postcards are electronically printed and may be kept by the user as a memento or souvenir of their trip or mailed to friends and relatives.

### CROSS REFERENCE TO RELATED APPLICATIONS

N/A

### STATEMENT REGARDING FEDERALLY SPONSORED RESEARCH OR DEVELOPMENT

N/A

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office patent file or records, but otherwise reserves all copyrights rights whatsoever.

### BACKGROUND OF THE INVENTION

1. Field of the Invention

The present invention relates to the field of electronic color imaging, and more particularly, to an apparatus for electronically producing printed picture postcards incorporating images provided by the user in digital format, or images of the user obtained by an integrated camera so as to produce a unique postcard product.

2. Description of Related Art

Travelers often desire to communicate with family and friends while traveling. Travelers also further wish to send a photograph or image of a place of interest encountered during the trip. One method of providing friends and family with such images involves taking pictures with standard roll-type film, having the film developed, the pictures printed, and mailing the pictures in an envelope having the proper postage affixed thereto. With advances in technology, travelers with digital cameras now have the ability to capture and store digital images. Digital cameras have proven effective in providing people with a simple, inexpensive, and convenient means of capturing and digitally storing images, but are relatively ineffective in transferring images while the user is traveling and does not have access to a computer. Often times, however, the traveler desires nothing more than to place a small message on the back of a postcard. Heretofore, there have been no devices available that allow travelers to create customized postcards that include images of the traveler or images provided by the traveler for instant printout.

Accordingly, there exists a need for an apparatus that is capable of accepting and/or producing a digital image, producing a personalized postcard using said digital image, affixing proper postage to the personalized postcard and printing the postcard.

### BRIEF SUMMARY OF THE INVENTION

The present invention overcomes the disadvantages in the art by providing an automated personal postcard dispensing apparatus capable of obtaining an image from a user and incorporating the image on a postcard along with a personalized text message to produce a customized postcard complete with proper postage affixed. An automated postcard dispensing apparatus according to the present invention is a computer device capable of capturing a digital image using an incorporated digital camera, scanner, CD/DVD reader, diskette drive, or memory card reader, and integrating the image into a personalized postcard along with a text message. In addition, the apparatus is configured to allow the user to determine proper postage, and print a personalized postcard complete with proper postage affixed.

The apparatus produces the postcard containing the an image provided by or selected by the user while allowing a clearly defined area on the postcard for a text message, the address of the intended recipient, and postage for immediate mailing. The apparatus further includes a device for receiving payment, either by coin, cash, or credit/debit card.

The apparatus includes a cash-receiving device, a computer, a video camera, a video monitor, a printer, a CD reader, a card reader, means to receive, store and, on command, present a pictorial background and instructions to the user flashed onto the monitor for quick and simple utilization by the user. The apparatus is preferably housed in a booth for location near heavily traveled tourist routes to facilitate use by many persons. The user is therefore easily able to send a fun, colorful record of their trip to friends and relatives showing them or an image selected by them, and further to save on postage costs by using postcard postage in lieu of letter postage. In addition, the postcards are electronically printed and may be kept by the user as a memento or souvenir of their trip or mailed to friends and relatives.

Accordingly, it is an object of the present invention to provide an automated postcard dispensing apparatus.

Another object of the present invention is to provide an automated postcard dispensing apparatus adapted for creating personalized postcards from images obtained by the user.

In accordance with these and other objects, which will become apparent hereinafter, the instant invention will now be described with particular reference to the accompanying drawings.

### BRIEF DESCRIPTION OF THE SEVERAL VIEWS OF THE DRAWINGS

FIG. 1 is a front view of an automatic postcard dispensing apparatus according to the present invention;

FIG. 2 is a detail view of the front upper left hand portion thereof;

FIG. 3 is a side perspective view thereof;

FIG. 4 is a bottom perspective view thereof;

FIG. 5 is a partial top perspective view thereof;

FIG. 6 is a rear view thereof with the back panel removed;

FIG. 7 is a detail view of the front upper right hand portion thereof; and

FIG. 8 is a flowchart depicting the steps related to producing and printing a customized postcard.

### DETAILED DESCRIPTION OF THE INVENTION

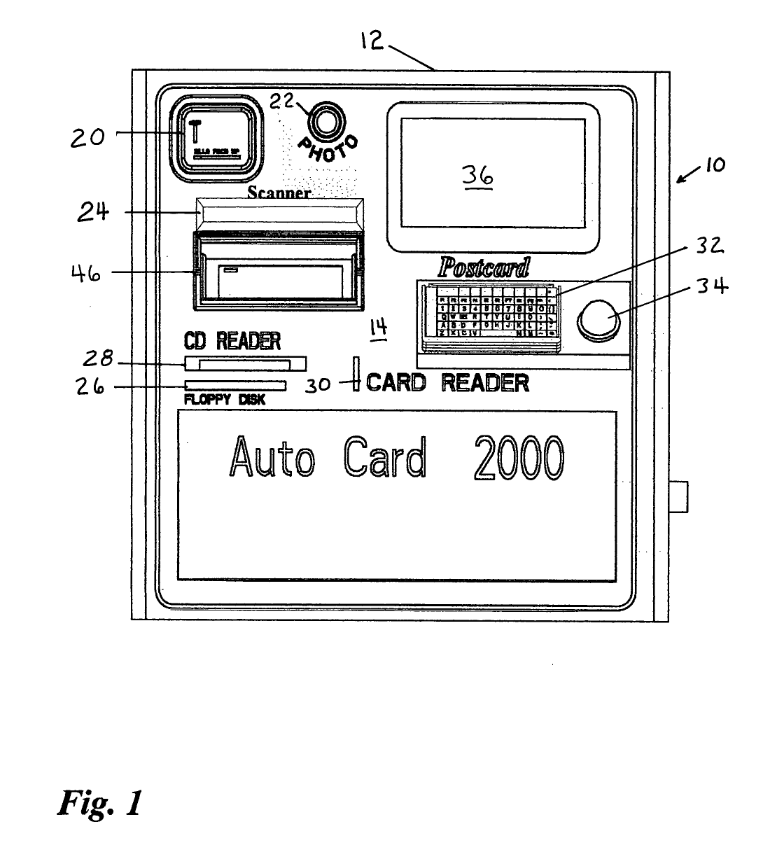

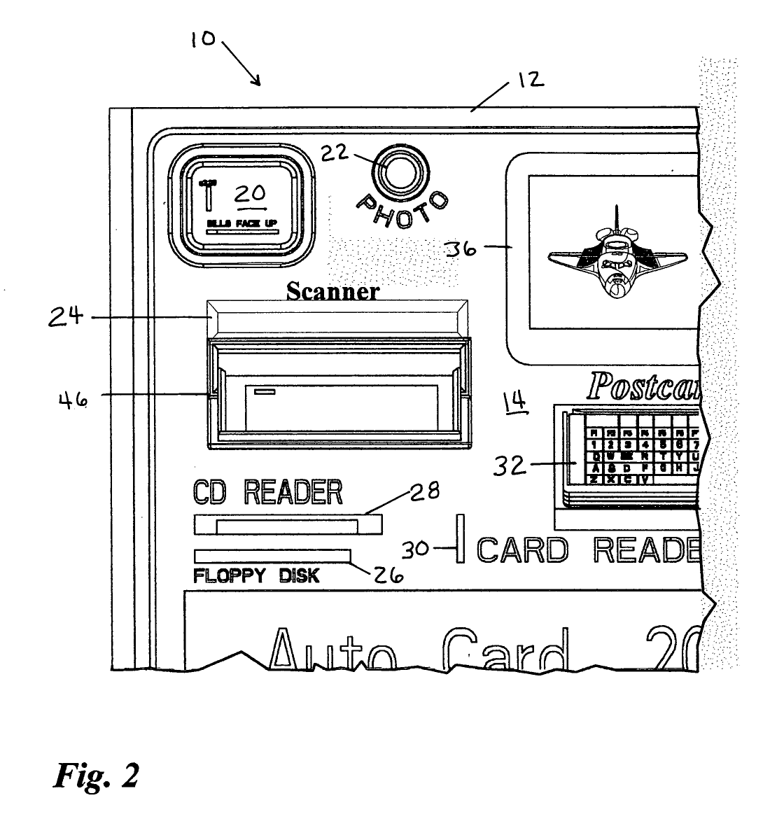

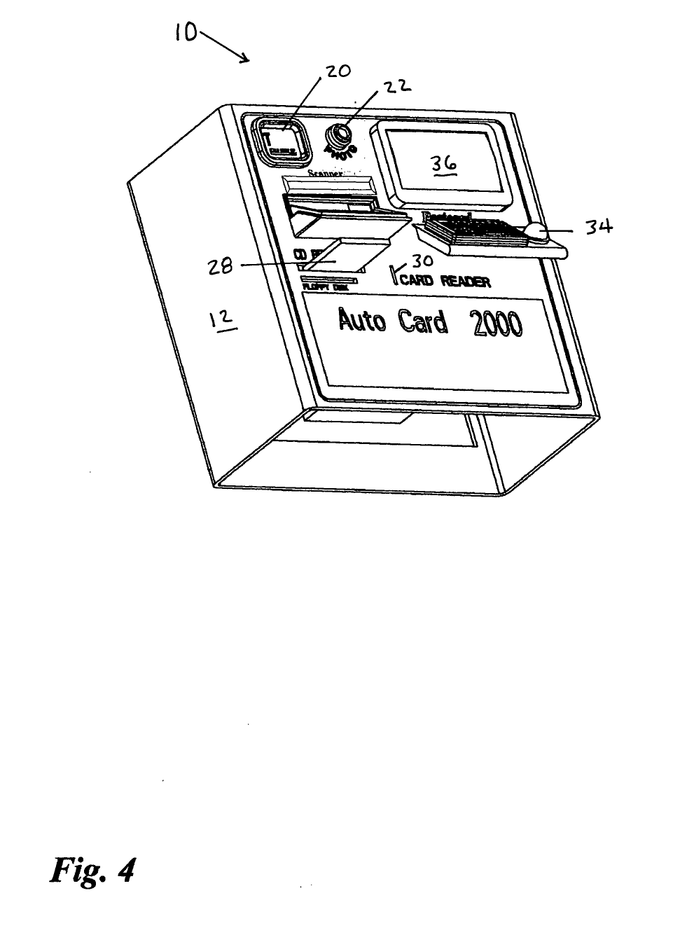

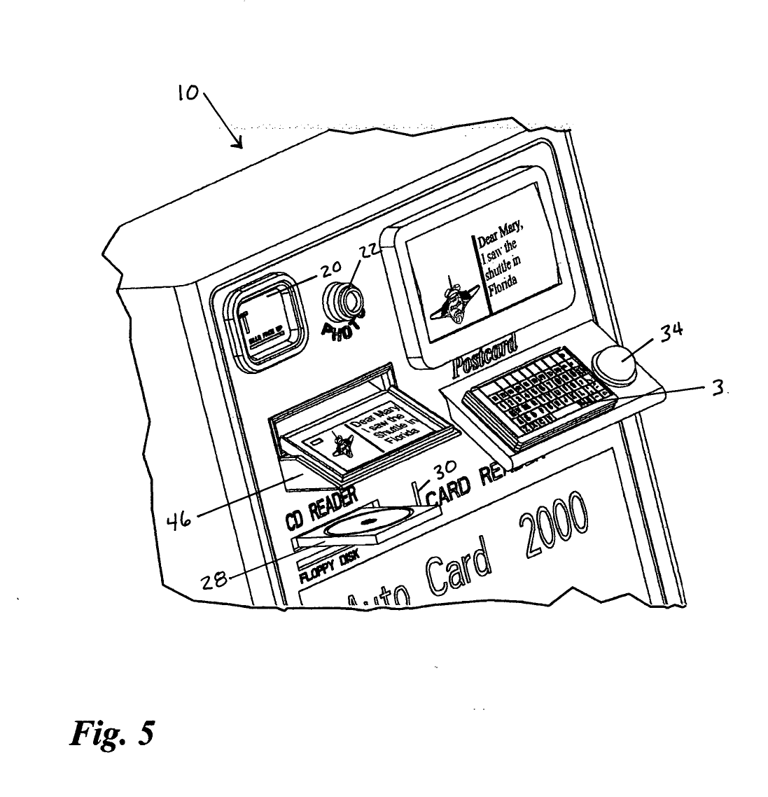

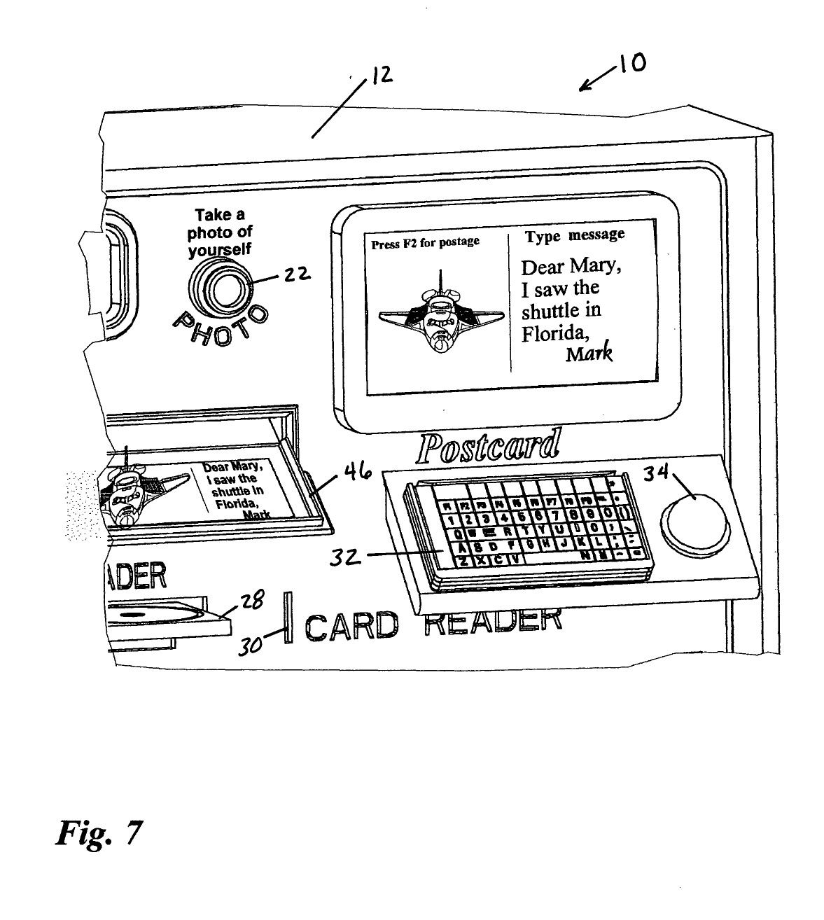

With reference now to the drawings, FIGS. 1-7 depict an automated postcard dispensing apparatus 10 in accordance with the present invention. Post card dispensing apparatus 10 comprises an automated vending apparatus for use by people to create customized personalized postcards. More particularly, an automated postcard dispensing apparatus according to the present invention is a computer device capable of capturing a digital image and integrating the image and/or one of a plurality of digitally stored images and backgrounds chosen by the user into a personalized postcard. In addition, the apparatus enables the user to incorporate a personalized text message, determine proper postage, and print a personalized postcard complete with proper postage affixed.

As best seen in FIGS. 1-7 post card dispensing apparatus 10 preferably includes a housing 12 that functions as a weatherproof enclosure for the mechanical and electrical components disclosed herein. Housing 12 includes a front side forming a user interface control panel, generally referenced as 14. Apparatus 10 includes a payment device 20 adapted for receiving payment by coin, cash, or credit/debit card. Payment device 20 further functions to activate the apparatus as further discussed herein. Included within housing 12 is a computer 13 having digital data storage capability.

A digital camera 22 is provided for obtaining a digital image or self-portrait of one or more persons present during the transaction. Digital camera 22 is preferably substantially contained within housing 12 with the lens thereof projecting through an opening in front panel 14 as best seen in FIG. 1. The lens is preferably mounted at a height corresponding to the height of an average person, and may further be adjustable by the user. Images captured by digital camera 22 are stored temporarily in a computer memory, such as a hard drive or RAM contained within housing 12.

In addition, Images may also be input via any one of a variety of input devices. More particularly, apparatus 10 includes a scanner 24 for allowing the user to scan in a previously printed photograph or other image. Furthermore, apparatus 10 is adapted to receive digitally stored images from various magnetic and optical media via a 3.5″ disk drive 26 and a CD/DVD reader 28. A card reader 30 is also provided to allow the apparatus to obtain digitally stored images from a memory stick or card. Card reader 30 is preferably a universal-type card reader having the capability to obtain data stored on any of the commonly available memory sticks and cards. Finally, a keyboard 32, equipped with a ball-type cursor controller 34, is provided to allow the user to input text by typing. Accordingly, the user may type personalized text messages and mailing addresses appearing on the postcard.

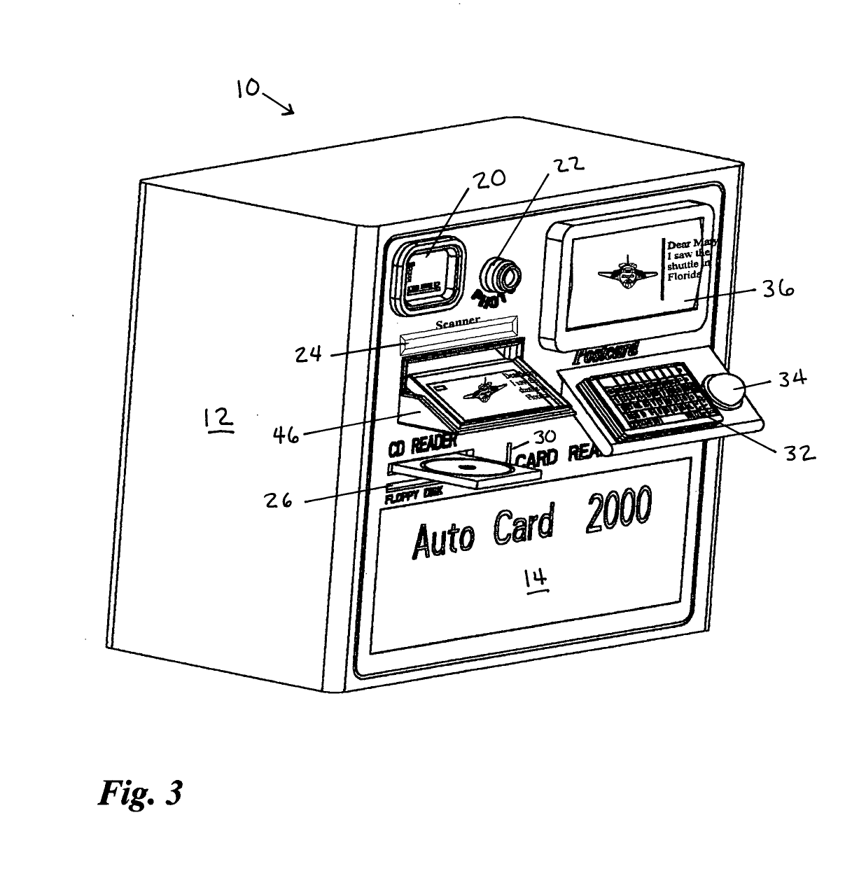

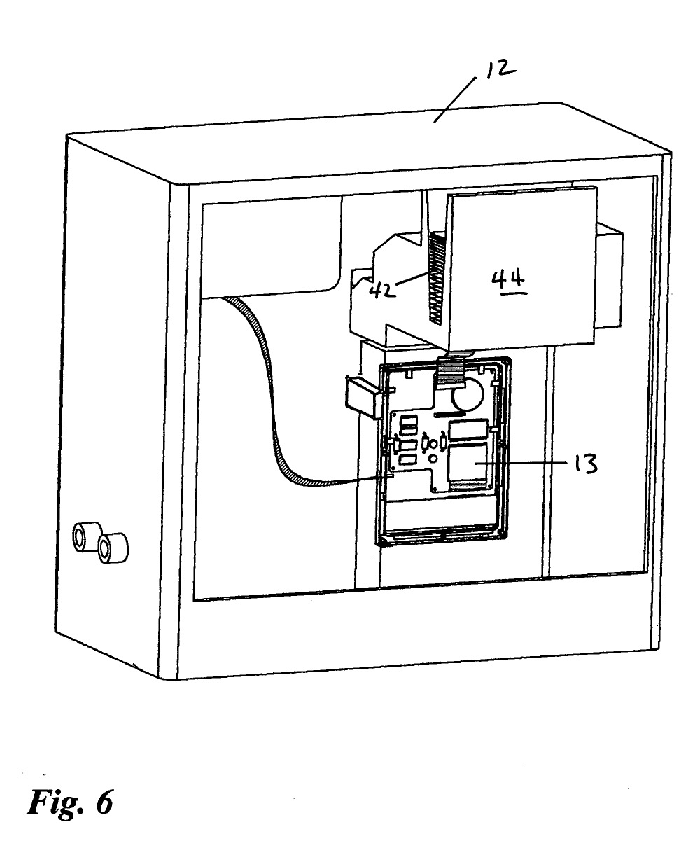

To allow the user to preview the postcard design, a display 36 is provided to allow the user to preview his or her postcard during the creation process to allow for editing and final approval prior to printing. Display 32 preferably comprises a liquid crystal display (LCD), however any suitable display, such as a CRT or flat panel monitor, is considered within the scope of the present invention. Once the user is satisfied with his/her personalized postcard as viewed on display 32, the user authorizes the printing, and dispensing of the card. Accordingly, apparatus 10 is further equipped with an internal color printer 40 having the capability of producing high quality, high resolution, color photograph quality prints. A supply of “blank” postcard sheets 42 are stored internally within housing 12 in a postcard sheet bin 44 to feed sheets into printer 40 as best seen in FIG. 6. Printer 40 has an output tray 46 disposed on front control panel 14 for receiving the printed postcards as best seen in FIG. 3.

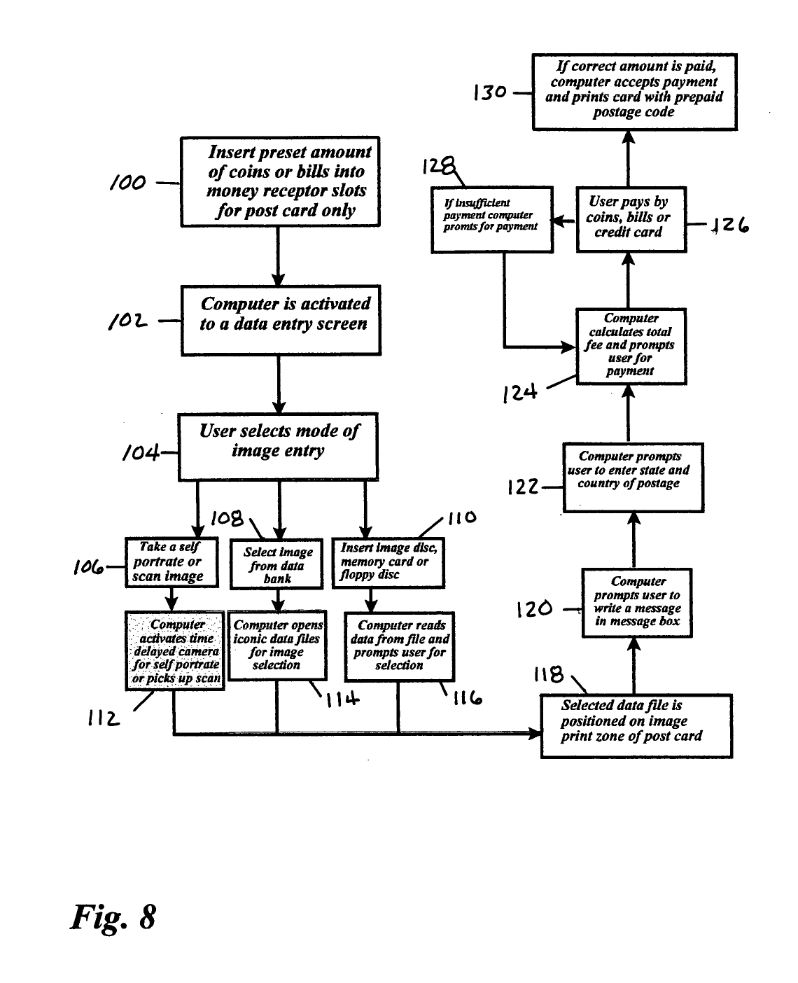

FIG. 8 is a flowchart depicting the steps related to producing and printing a customized postcard. As shown in step 100, the user inserts coin, cash, or a credit card to provide payment of a predetermined amount into payment device 20 of apparatus 10. In a preferred embodiment, the initial payment is for the creation of the postcard only and does not include postage as it is contemplated that the user may wish to affix his or her own stamps. As shown in step 102, the initial payment activates the system and an internal computer processor causes display 36 to generate a data entry screen. As shown in step 104, the user then is prompted to select the mode of image entry. Step 106 illustrates a selection wherein the user selects to either create a self-portrait using camera 22, or scan an image into the apparatus using scanner 24. As shown in step 112, step 106 activates camera 22 in a time delay mode wherein the user is allowed some time (i.e. 10 seconds) to pose in front of the camera, or alternatively activates scanner 24 to scan a preprinted photograph or image supplied by the user. Step 108 illustrates a selection wherein the user selects an image from a database of digital images stored in apparatus 10. Selection of this option causes the computer to open data files and display available images for selection on display 36. The images may be displayed full size for viewing one at a time, or may be displayed in thumbnail view such that a plurality of images are displayed simultaneously for selection on display 36. Finally, step 110 illustrates an option wherein the user may provide an image by insertion of a CD/DVD, floppy disk, or memory stick. Upon selection of step 110, the computer reads data from the media inserted and prompts the user to select the desired image.

Once the desired image is obtained, the apparatus positions the image on an image print portion of the post card as seen in step 118. In a preferred embodiment, the postcard is partitioned in half with one half functioning to receive an image and the other half functioning to receive text. Accordingly, as seen in step 120, upon proper receipt and positioning of the image the computer prompts the user to type in a text message using keyboard 32. In accordance with step 122, the computer then prompts the user to enter location of the desired recipient, e.g. country, state, zip code, etc. As seen in step 124 the postage is then calculated based on the information provided by the user. The user then completes the transaction by providing additional payment to cover the postage as depicted in step 126. In the event that the payment is insufficient, the computer prompts the user for an additional sum 128. Once the correct amount is paid, the postcard is printed with proper postage affixed as seen in step 130.

As noted above, an image may be chosen from a plurality of stored images that may be indigenous to the area wherein the apparatus is located (i.e. Washington Monument, Golden Gate Bridge, etc.) thereby eliminating the need of the user to physically be at that background when the self-portrait is integrated therein or pictorially represent other backgrounds. The apparatus produces the postcard containing the image supplied by the user integrated therein while allowing a clearly defined area on the postcard for a text message, the address of the intended recipient, and postage for immediate mailing.

The apparatus is preferably placed in a public location near heavily traveled tourist routes to facilitate use by many persons. The user is therefore easily able to send a fun, colorful record of their trip to friends and relatives showing them in front of a choice of backgrounds without bothering others to take their picture, be photographed in backgrounds showing locations they may not, for one reason or another, be able to visit or photograph and further to save on postage costs by using postcard postage in lieu of letter postage. In addition, the postcards are electronically printed and may be kept by the user as a memento or souvenir of their trip or mailed to friends and relatives.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. Apparatus for automatically producing personalized and customized postcards, said apparatus comprising:
a payment receiving device for receiving a payment of money and producing electronic signals in response to said payment;
a computer connected to said payment receiving device and programmed with a set of instructions that define a series of operating sequences, said computer including a digital data storage medium, a display, and a keyboard;
a plurality of location specific images stored in said data storage medium;
said display mounted within view of the user, for receiving a real time image of the user;
at least one digital image input device, said at least one digital image input device including a digital camera having an output connected to said computer, said camera having a lens oriented toward the user;
a color printer adapted for printing color images and affixing postage, said color printer including a bin having a plurality of blank post cards;
said computer responsive to signals from said payment receiving device to initiate a set of data entry steps including:
prompting the user for image entry from said at least one digital image input device;
obtaining a digital image from the user;
positioning said digital image relative to a postcard;
prompting the user to enter a text message using said keyboard;
prompting the user to enter location information for the intended recipient;
calculating postage based on said location information;
prompting the user for additional payment for postage; and
printing a postcard with the image provided by the user, the text message provided by the user, and proper postage affixed.

2. An apparatus for automatically producing personalized and customized postcards, according to claim 1 wherein said at least one digital image input device includes a scanner connected to said computer.

3. An apparatus for automatically producing personalized and customized postcards, according to claim 1 wherein said at least one digital image input device includes a CD/DVD reader connected to said computer.

4. An apparatus for automatically producing personalized and customized postcards, according to claim 1 wherein said at least one digital image input device includes a memory card reader connected to said computer.

5. An apparatus for automatically producing personalized and customized postcards, according to claim 1 wherein said at least one digital image input device includes a disk drive connected to said computer.

6. An apparatus for automatically producing personalized and customized postcards, according to claim 1 wherein said keyboard further includes a ball-type cursor controller for allowing the user to position the digital image.

7. Apparatus for automatically producing personalized and customized postcards, said apparatus comprising:
a payment receiving device for receiving a payment of money and producing electronic signals in response to said payment;
a computer connected to said payment receiving device and prorammed with a set of instructions that define a series of operating sequences, said computer including a digital data storage medium, a display, and a keyboard;
said display mounted within view of the user, for receiving a real time image of the user;
a digital camera having an output connected to said computer, said camera having a lens oriented toward the user;
a scanner having an output connected to said computer;
a CD/DVD reader having an output connected to said computer;
a memory card reader having an output connected to said computer;
a disk drive having an output connected to said computer;
a color printer adapted for printing color images and affixing postage, said color printer including a bin having a plurality of blank post cards;
said computer responsive to signals from said payment receiving device to initiate a set of data entry steps including:
prompting the user select a mode of image entry using one of said digital camera, scanner, CD/DVD reader, memory card, or disk drive;
obtaining a digital image from the user;
positioning said digital image relative to a postcard;
prompting the user to enter a text message using said keyboard;
prompting the user to enter location information for the intended recipient;
calculating postage based on said location information;
prompting the user for additional payment for postage; and
printing a postcard with the image provided by the user, the text message provided by the user, and proper postage affixed.
